(19) United States
(12) Patent Application Publication
(10) Pub. No.: US 2012/0090551 A1
(43) Pub. Date: Apr. 19, 2012

(54) SPRAY CLEANSING AND SPRINKLERS

(76) Inventor: Jesus Evaristo Guajardo Torres, Mexico (MX)

(21) Appl. No.: 13/265,721

(22) PCT Filed: Apr. 23, 2010
(86) PCT No.: PCT/MX10/00036

§ 371 Date: Jan. 2, 2012

(30) Foreign Application Priority Data
Apr. 23, 2009 (MX) MX/A/2009/004348

(51) Int. Cl. A01K 13/00

(52) U.S. Cl. 119/671

(57) ABSTRACT

This invention refers to a device for spray cleansing animals, being this a saving device because the arrangement of elements allows or guarantees a thorough animal cleansing which eliminates parasites, dirt, and bacteria into and out of animal's fur and skin, within an average time of 5 seconds per animal, besides the fact that it has a collection or recovery system for water with poison and chemicals and a filtering system which avoids loss of them, since it is reused. Also, sprinkles permit the provision of a water ring with regulated volume and pressure, allowing the opening of animal's fur and penetration to skin.

### FIELD OF INVENTION The purpose of this invention is to provide a device to cleanse livestock in order to exterminate external parasites in cattle, goats, sheep and horses.

### BACKGROUNDS

### Immersion Cleansing

This type of bath represents an elevated cost for both, construction and operation, and the results are not always satisfactory. The construction of this model is very expensive, the materials may not always be found because these kinds of models can only be acquired in places of difficult access or far away from the service providers. This bathing area consists of a narrow, long, and deep pit which is placed on a chute to cleanse animals.

The operation in this model causes stress in livestock due to the type of operation and design management. There are many risks of intoxication by the ingestion of treated waters since they are stagnant, dirty, and contaminated by animal waste which produces stomach damage and may cause miscarriages, and irreversible damage such as fractures and even drowning in animals.

Due to the length and depth of the pits, the animals cannot get out; some of them may even get stuck to each other at the moment of immersion.

As consequence of the stress produced in animals, they defecate and urinate in these waters; in turn, this waste gets into the drainboard. Since the drainboard is in the open, cleansing quality and effect deteriorate.

In order to prevent the bathing area from cracking, it must always contain water, which is deteriorated by the passage of those same animals and by the time of inactivity. The water is filtered, and upon reuse, the levels have to be reestablished and the amount of chemicals or poison applied must be doubled, according to what recommended by laboratories, which represents environmental deterioration and high-cost operations; in addition, good results are not always obtained, causing external parasite resistance due to the imprecise dosage.

### Backpack Sprayer or Tank Dosifier Cleansing

This cleansing is carried out manually by a person, either with a backpack sprayer and/or with a water tank. The operation of this model is very imprecise and slow, operation costs are high since the treated water is no recovered but wasted, damaging the environment and ecology, besides the fact that it is a very tiring and little practical method, since it does not impregnate hot animal parts, like udders, groins, and ears, which usually contain these parasites.

### BRIEF DESCRIPTION OF FIGURES

FIG. 1 is a front view of spray cleansing which shows the whole system.

FIG. 2 is a bottom view of spray cleansing which shows the sprinklers of the base or floor.

FIG. 3 is a lateral view of spray cleansing which shows the sprinklers as well as the recovery tray.

FIG. 4 is a lateral view which shows the brackets supporting the tunnel.

FIG. 5 is a top view of the calibration and spray irrigation nut which shows its outlet perforation and coincidence.

FIG. 6 is a view of the calibration and spray irrigation nut.

FIG. 7 is a top view of the spray adjustment nut.

FIG. 8 is a lateral cross section of the sprinkler, which shows the difference of internal diameters as well as the diameter increase at the top.

FIG. 9 is a view of the sprinkler already assembled with its calibration and adjustment nuts.

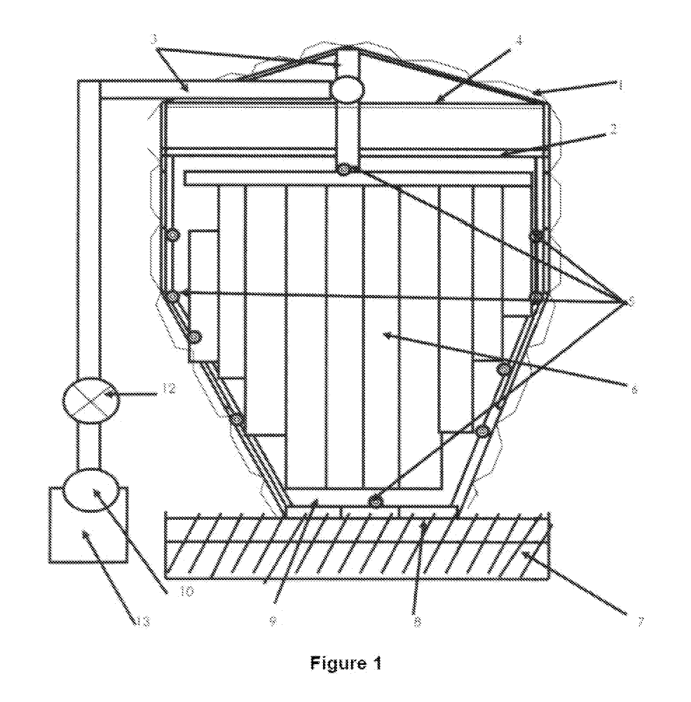

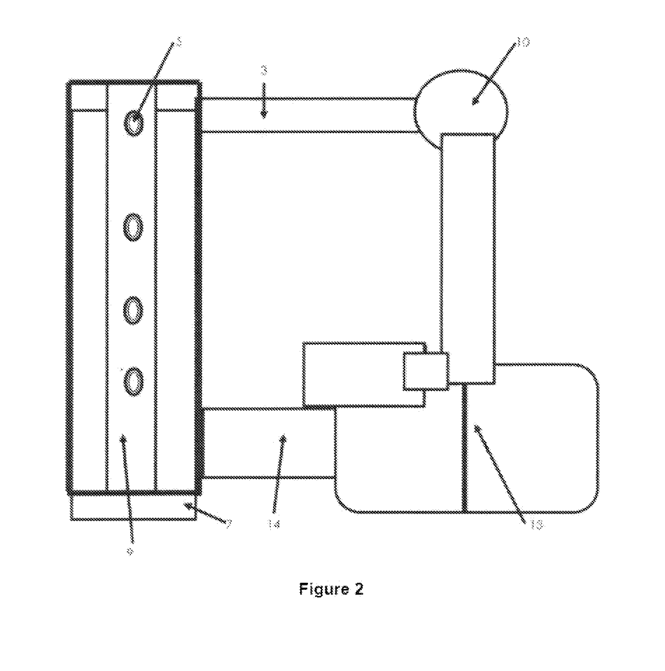

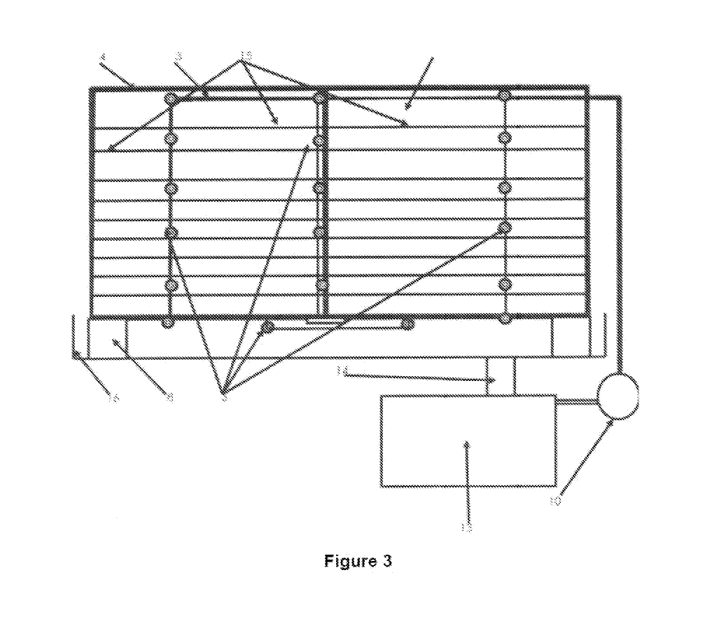

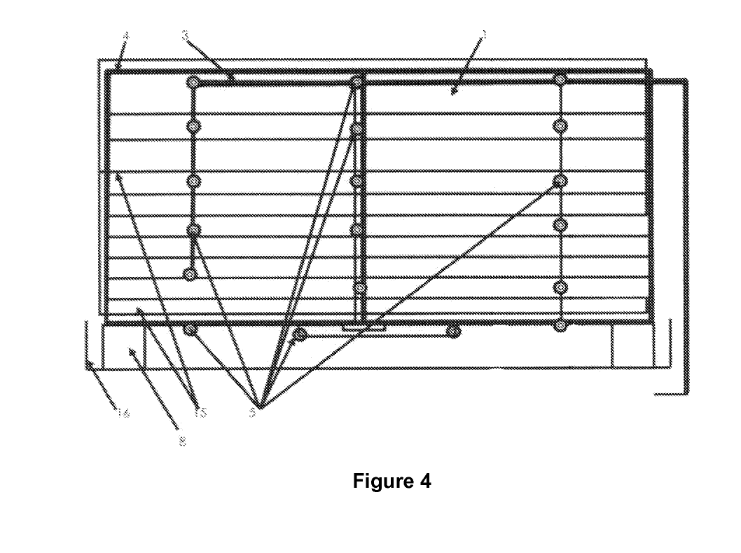

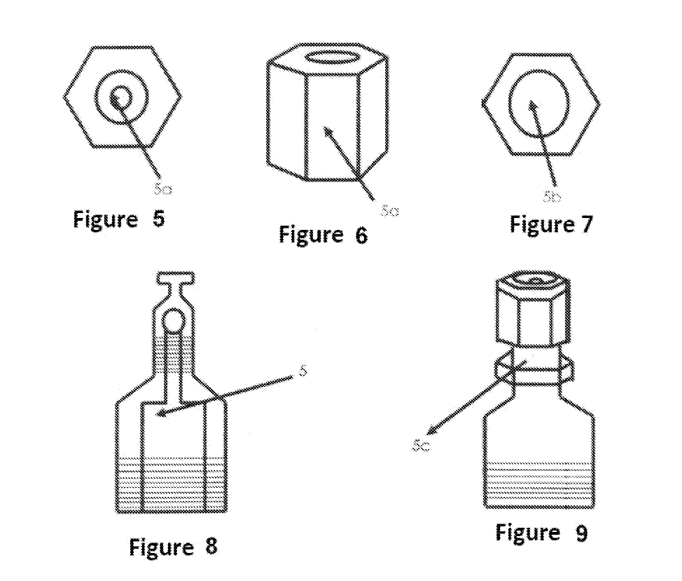

### DESCRIPTION OF THE INVENTION

Spray cleansing is a model developed to support land work, ease livestock management, labor, and reduce operation costs. It also increases the quality of livestock cleansing.

This model resembles a lined tunnel (1) through which livestock passes and impregnates with treated water, permitting the flow of up to 720 animals per hour. Its application consumption is very low since the exceeding water is reused, thus avoiding ecological damage and lowering producers' operation costs. One of the advantages of spray cleansing is the recovery tray (7) which passes through several filters consisting of 4 galvanized-mesh filters before the pump suction cycle in order to eliminate the garbage that could clog the sprinklers; the water is recycled and resprayed, thus reducing the treated water consumed by livestock, evaporation and drain. Water volume required for animals cleansing is significantly reduced since water is limited or salty in some places.

Spray cleansing consists of a tubular structure (4) preferably PVC, which is free from erosion and adhered materials, and the structure is tunnel-shaped (4) through which animals shall pass to be cleansed. It is formed by a base which consists of some rectangular beams arranged along the tunnel, which are fixed and linked by some perpendicular crossbeams to these beams. In the lower part of the base, which is supported by two supporting pieces, is a recovery tray (7) which shall contain all runoffs derived from the cleansing area. Water shall drain between that space located between beams and crossbeams, these runoffs are water and chemicals or poison, etc. This tray (7) is rectangular and covers all cleansing area bottom; this tray (7) has a water discharge channel (14) which sends contained water to a recycling and filtering tank (13), same which is divided with several mosquirred-type gratings, which are a chain link fabric with very small orifices which do not allow flies or ticks cleansed from livestock during the process, thus retaining all solid sediments drained after cleansing. Therefore, we will have water with sediments on one side, and the water free of solids on the other. That is where water-poison solution is extracted again through a solution hose, which has another inlet filter. Water is suctioned by a pump, which (10) resends liquid to the sprinklers (5) through a piping system (11) (3), preferably PVC or any plastic material. Between the pump (10) and the sprinklers (5) is a screw-down valve (12) used upon cleansing area cleaning or discharge. The main tunnel structure (4) consists of some frames forming a trapezoid structure, whose narrower part joins the base, and the wider part faces the top. At the end of the trapezoid, the same frame has a vertically oriented fold; in the top, these structures are joined by some upper horizontal crossbeams completing the frame structure. The frames are connected to each other through some upper supporting pieces, forming the tunnel structure (4), thus supporting the structure and the walls of the cleansing area lining (15). The tunnel's bottom is narrower than the top since animal bodies so require. Along the tunnel and by its lateral ends, the structure (4) is joined through some lateral beams, from where lateral sprinkles stick out in different positions. In the area where sprinklers are located in the tunnel, it contains some protecting crossbeams, which prevent the animal from somehow damaging the sprinklers (5). At the bottom, the narrower part of the tunnel, lateral beams conforming the wall (15) are closer one another to prevent animals from putting their legs in; it has to contain at least 4 of these beams in both sides. At the vertical part of the same tunnel, there are other beams (15) now positioned far from each other in order to support the structure as well as to protect the sprinklers (5). At the top, it has two supporting pieces and a series of sprinklers arranged along the tunnel (4) and connected to the upper crossbeams. All lateral and external part of the structure has some girders or trusses, which support a hitting sheet or lining (1), which avoids water loss by retaining it and draining it into the recovery tray (7). The tunnel's (4) lateral and upper ends are lined.

Sprinklers (5) are arranged at the bottom, side and top of the cleansing tunnel; lateral sprinklers (5) are placed at different levels, lateral left sprinklers at a different level from right sprinklers, avoiding water jet hit, which streamlines the use of water with poison or chemicals for cleansing animals, which is the subject of this invention, since no other invention was found in the state of the art using sprinklers asymmetrically to prevent particles or drops of water from hitting.

Also, outflow pressure of the water supplied by the pump (10) to the sprinklers (5), is regulated to approximately 5 kg/cm², which guarantees the penetration of water with poison or chemicals into fur, thus eliminating parasites, dirt, and bacteria found inside animal's fur. It is important to mention that the arrangement of sprinklers as well as the pressure of outflowing water regulated to approximately 5 kg/cm² are aimed also at opening the fur in order to help penetration of water with poison or chemicals without damaging the animal's skin, which would turn them violent, thus damaging the cleansing area structure.

In addition, this invention has sprinkles in the bottom, which allow to freely cleansing the lower parts of the animal, such as udders, chest, and genitals. This increases the quality or efficiency of animal cleansing guaranteeing penetration of water with poison or chemicals into all their bodies.

In the back and front of the tunnel, the cleansing area has a Hawaiian style plastic curtain (6), which is formed by a crossbar which supports some plastic vertical strips (6) which prevent breeze from escaping from the tunnel and are fixed to the upper supporting pieces.

The cleansing area may have 2 modalities, a mobile modality and a fix modality. The fix modality would be adapted or fixed in a section of the barn chute, whereas the mobile modality would be put upon a trailer, which contains some stabilizing structures supporting the weight when being at the work place; likewise, two ramps are adapted, an entrance ramp, and an exit ramp through which the animal is led, having the same shape as the aforementioned tunnel, wider in the top than in the bottom. In this case, the recovery tray (7) is the same recycling tank, (13) from there it will go through to a filling tank (13) next to the same tray (7) working under the same system.

Sprinklers (5) consist of a cylindrical main body which has four external diameters; the larger diameter has a thread (5a), from there it has a flat section (5b) and then, there is a diameter reduction; again, the second diameter has an external thread which receives the sprinkler nut (5b) and the spray calibration nut (5a). After the second thread, the sprinkler has an orifice which transversally crosses its body, which will be the water outlet, (5c) and in the top of the sprinkler (5), it has a new conical reduction ending in an increase of diameter where water will hit (5c). A calibration adjustment nut (5a) is placed on the thread of the second diameter; this has a fixation system through a screw, which is inside this nut, perpendicular to the sprinkler, and adjusts the place where the water flow is calibrated. A spray calibration nut (5a) is placed on top of the sprinkler (5) coiling up to the spray adjustment nut (5b), for water outflow. The water will pass through into the sprinkler, whose diameter is reduced in the bottom, exerting more pressure upon exiting. The water exits through said transversal orifices and is kept in a chamber formed by the sprinkler (5) and the adjustment nut (5b); it shall go on through the conical reduction and hit into the above mentioned increase of diameter from where it shall move through a concave-conical shape at the top of the calibration nut (5a) thus forming a concave water outlet known as water ring.

The pipe system is formed by a principal supplying pipe (3) which sends water to the top of the cleansing area, where is distributed to some secondary supplying pipes (2) placed along the sides of the cleansing area and to which the sprinklers are connected (5). The sprinklers distribute water to cleanse animals; then, runoffs and residual water is contained in the recovery tray (7), and from there, they go to the recycling and filtering tank (13). This same water shall be sent again to the pipe by the pump (10) thus closing the cycle.

### LIST OF COMPONENTS OF THE SPRAY CLEANSING

1. Spray cleansing area lining.

2. Secondary supplying pipe.

3. Principal supplying pipe.

4. Tunnel supporting structure.
5. Sprinklers.
   5a. Spray calibration nut.
   5b. Spray adjustment nut.
   5c. Sprinkler body.

6. Plastic curtains.

7. Recovery tray.

8. Structure's lower support.

9. Cattle traffic aisle or base.

10. Self-priming pump.

11. Principal pipe for water supply.

12. Shut-off valve.

13. Recycling, filtering, and dosage tank.

14. Discharge channel.

15. Barn wall.

16. Principal tank for recovery of water excess.

1. Spray cleansing and sprinklers is characterized because it consists of a tunnel-shaped structure, preferably metallic, which in the bottom has a base formed by some beams arranged along said tunnel; these beams are connected through some crossbeams, slightly separated from each other, allowing passage of liquids. The lateral extremes of the base are connected to some frames, which have a trapezoid form, whose narrower part joins the base, and the wider part is located towards the top. At the end of the trapezoid, the same frame has a vertically oriented fold; in the top, these structures are joined by some upper horizontal crossbeams completing the frame structure. The frames are connected to each other through some upper supporting pieces, forming the tunnel structure, thus supporting the structure and the walls of the cleansing area lining. Along the tunnel and by its lateral ends, the structure is joined through some lateral beams, from where lateral sprinkles stick out in different positions. In the area where sprinklers are located in the tunnel, it contains some protecting crossbeams, forming a box as a means of protection. At the bottom, the narrower part of the tunnel, lateral beams are arranged one after the other with little separation between them as precaution means, thus avoiding the entrance of animal legs; it has to contain at least 4 of these beams in both sides. At the vertical part of the same tunnel, there are other beams now positioned at a wider separation than previous ones in order to support the structure. At the top, among the superior supporting pieces, a series of sprinklers arranged along the tunnel. Lateral and external parts of the structure have some girders or trusses on which a hitting sheet or lining shall be fixed, thus preventing water from escaping; the tunnel's lateral and upper ends are lined. Sprinklers are distributed in the tunnel's bottom, side and top. In the back and front of the tunnel, the cleansing area has a Hawaiian-style plastic curtain, which is formed by a crossbar which supports some plastic vertical strips which are fixed to the upper supporting pieces. Under the tunnel's base, which is supported by two brackets, there is a recovery tray, where all runoffs derived from the cleansing shall be contained. This tray is rectangular and covers all cleansing area's bottom. This tray has an outlet which sends the water contained to a recycling and filtering tank, same which is divided with a grating which shall retain all solid sediments drained after cleansing, thus having water with sediments on one side, and free-of-solids water on the other. The water-chemical solution is extracted through an extracting hose, which has another inlet filter. The water is extracted by a pump, same which is activated through en engine. The pump sends the liquid again to the sprinklers through a pipe system, thus closing the cycle, preferably PVC or any plastic material. Between the pump and the sprinklers, there is a screw-down valve used upon cleaning or discharging the cleansing area.

2. Spray cleansing and sprinklers, according to claim 1, characterized due to the fact that the sprinklers are formed by a cylindrical main body which has four external diameters; the first section has the largest diameter, same which is coiled up; the other part of the same section has a flat body and then, there is a diameter reduction. A second section has a second diameter, shorter than the previous one. As well as the first diameter, this has an external thread which receives the sprinkler nut and the spray calibration nut. After the second thread, the sprinkler has an orifice which transversally crosses its body. In a third section, the top of the sprinkler has a new conical reduction of its diameter ending in a fourth section with an increased diameter, where water flow will hit. A calibration adjustment nut is placed on the thread of the second diameter; this as a fixation system through a screw, which is inside this nut, perpendicular to the sprinkler, and adjusts the place where the water flow is calibrated. A spray calibration nut is placed on top of the sprinkler coiling up to the spray adjustment nut. At the bottom of the nut there is a reduced diameter as a means of pressure for outflowing water; a chamber is formed by the sprinkler and the calibration nut, where water shall flow towards the conical reduction of the sprinkler and hit against the increased diameter of the fourth section of the sprinkler, moving in such way against a conical form located in the top of the calibration nut, thus forming a concave water outlet known as water ring.

3. Spray cleansing and sprinklers, according to claims 1, characterized due to the fact that the cleansing area may have 2 modalities, a mobile modality and a fix modality. The fix modality would be adapted or fixed in a section of the barn chute, whereas the mobile modality would be put upon a trailer, which contains some stabilizing structures supporting the weight when being at the work place;
likewise, two ramps are adapted, an entrance ramp, and an exit ramp through which the animal is led, having the same shape as the aforementioned tunnel, wider in the top than in the bottom. In this case, the recovery tray is the same recycling tank, from there it will go through to a filling tank next to the same tray working under the same system.

4. Spray cleansing and sprinklers, according to claim 2, characterized due to the fact that the sprinklers have variable or calibratable spray irrigation.

5. Spray cleansing and sprinklers characterized due to the fact that the sprinklers are asymmetrically arranged, it means, at different levels; left lateral sprinklers differ from the right lateral sprinklers, thus preventing the water jet from hitting.

6. Spray cleansing and sprinklers characterized due to the fact that the exit pressure of water sprinklers is regulated to approximately 5 kg/cm², which guarantees penetration of water with poison or chemicals into fur in order to eliminate parasites, dirt, ad bacteria found in animal's fur.

7. Spray cleansing and sprinklers, according to claim 6, characterized due to the fact that the arrangement of sprinklers, as well as the regulated pressure of outflowing water, is aimed at opening the fur to help water with chemicals and poison penetrate without hurting animal's skin

8. Spray cleansing and sprinklers, according to claim 1, characterized due to the fact that the arrangement of all elements forming this invention allow a thorough cleanse of the animal, eliminating parasites, dirt, and bacteria found into and out of the animal's fur and skin within an average time of 5 seconds per animal cleansing.

9. Spray cleansing and sprinklers, which according to claim 1, allows an infinite number of mixtures use of chemicals with water to cleanse animals.

10. Spray cleansing and sprinklers, which according to claim 1, is characterized due to the fact that this invention has a filtering system that consists of a “mosquirred”-type chain link fabric.

11. Spray cleansing and sprinklers, according to claim 2, characterized due to the fact that the cleansing area may have 2 modalities, a mobile modality and a fix modality. The fix modality would be adapted or fixed in a section of the barn chute, whereas the mobile modality would be put upon a trailer, which contains some stabilizing structures supporting the weight when being at the work place; likewise, two ramps are adapted, an entrance ramp, and an exit ramp through which the animal is led, having the same shape as the aforementioned tunnel, wider in the top than in the bottom. In this case, the recovery tray is the same recycling tank, from there it will go through to a filling tank next to the same tray working under the same system.

12. Spray cleansing and sprinklers, according to claim 2, characterized due to the fact that the arrangement of all elements forming this invention allow a thorough cleanse of the animal, eliminating parasites, dirt, and bacteria found into and out of the animal's fur and skin within an average time of 5 seconds per animal cleansing.

13. Spray cleansing and sprinklers, according to claim 5, characterized due to the fact that the arrangement of all elements forming this invention allow a thorough cleanse of the animal, eliminating parasites, dirt, and bacteria found into and out of the animal's fur and skin within an average time of 5 seconds per animal cleansing.

14. Spray cleansing and sprinklers, according to claim 6, characterized due to the fact that the arrangement of all elements forming this invention allow a thorough cleanse of the animal, eliminating parasites, dirt, and bacteria found into and out of the animal's fur and skin within an average time of 5 seconds per animal cleansing.

15. Spray cleansing and sprinklers, which according to claim 2, allows an infinite number of mixtures use of chemicals with water to cleanse animals.

16. Spray cleansing and sprinklers, which according to claim 2, is characterized due to the fact that this invention has a filtering system that consists of a “mosquirred”-type chain link fabric.

17. Spray cleansing and sprinklers, which according to claim 5, is characterized due to the fact that this invention has a filtering system that consists of a “mosquirred”-type chain link fabric.

18. Spray cleansing and sprinklers, which according to claim 6, is characterized due to the fact that this invention has a filtering system that consists of a “mosquirred”-type chain link fabric.

19. Spray cleansing and sprinklers, which according to claim 7, is characterized due to the fact that this invention has a filtering system that consists of a “mosquirred”-type chain link fabric.

20. Spray cleansing and sprinklers, which according to claim 8, is characterized due to the fact that this invention has a filtering system that consists of a “mosquirred”-type chain link fabric.
